(19) United States
(12) Patent Application Publication
(10) Pub. No.: US 2018/0107581 A1
(43) Pub. Date: Apr. 19, 2018

(54) SYSTEM TO SUPPORT I18N-FRIENDLY PRODUCT AGILE DEVELOPMENT AND ENABLE CONTINUOUS IMPLEMENTATION AND DELIVERY

(71) Applicant: CA, Inc., New York, NY (US)

(72) Inventors: Nivedita AGGARWAL, Hyderabad (IN); Smrati GUPTA, Barcelona (ES); Victor Muntés MULERO, Barcelona (ES); Patricia Paladini ADELL, Barcelona (ES)

(73) Assignee: CA, Inc., New York, NY (US)

(21) Appl. No.: 15/294,001

(22) Filed: Oct. 14, 2016

(51) Int. Cl. G06F 11/36; G06F 9/44

(52) U.S. Cl. CPC G06F 11/3604; G06F 9/4448

(57) ABSTRACT

A method for controlling and visualizing an internationalization process may include detecting a plurality of modules within source code, determining a respective status for each of the plurality of modules, formatting for display at a graphical user interface the respective status for each of the plurality of modules, parsing the plurality of modules to determine whether any particular module has one of a plurality of predetermined internationalization issues, and determining that a particular module has one of the plurality of predetermined internationalization issues. In response to determining that the particular module has one of the plurality of predetermined internationalization issues, the method may include updating the respective status of the particular module to a first status. The method may include modifying the particular module to address the one of the plurality of predetermined internationalization issues and in response to modifying the particular module, updating the respective status from the first status to a second status.

### BACKGROUND

The present disclosure relates to detecting internationalization issues in source code, more particularly, to systems and methods for detecting potential internationalization issues as early as possible during the software development process.

Software companies continuously innovate in order to provide the best services to meet customer needs. Markets evolve quickly, putting pressure on software companies to develop and manage new product features and follow a continuous delivery approach. Product internationalization (i18n), including localization (L10n), has become an essential step for software companies to allow them to access global markets. A lack of internationalization and localization may lead to customer dissatisfaction and may damage the image of software enterprises and customer loyalty. Product internationalization costs, in particular localization, may be significant. Internationalization usually adds long time to market periods for products to be released that need to be translated to languages other than English. This may jeopardize agility and may become a potential risk for fast innovation.

### BRIEF SUMMARY

According to an aspect of the present disclosure, a method may include the steps of detecting a plurality of modules within source code; determining a respective status for each of the plurality of modules; formatting for display at a graphical user interface the respective status for each of the plurality of modules; parsing the plurality of modules to determine whether any particular module has one of a plurality of predetermined internationalization issues; determining that a particular module has one of the plurality of predetermined internationalization issues; in response to determining that the particular module has one of the plurality of predetermined internationalization issues, updating the respective status of the particular module to a first status; modifying the particular module to address the one of the plurality of predetermined internationalization issues; and in response to modifying the particular module, updating the respective status from the first status to a second status.

According to another aspect of the present disclosure, a computer configured to access a storage device may include a graphical user interface; a processor; and a non-transitory, computer-readable storage medium storing computer-readable instructions. The instructions when executed by the processor may cause the computer to perform: detecting a plurality of modules within source code; determining a respective status for each of the plurality of modules; formatting for display at the graphical user interface the respective status for each of the plurality of modules; parsing the plurality of modules to determine whether any particular module has one of a plurality of predetermined internationalization issues; determining that a particular module has one of the plurality of predetermined internationalization issues; in response to determining that a particular module has one of the plurality of predetermined internationalization issues, updating the respective status of the particular module to a first status; modifying the particular module to address the one of the plurality of predetermined internationalization issues; and in response to modifying the particular module, updating the respective status from the first status to a second status, wherein updating the respective status of the particular module to the second status results in a corresponding change at the graphical user interface.

According to another aspect of the present disclosure, a non-transitory computer-readable storage medium may have instructions stored thereon that may be executable by a computing system to: detect a plurality of modules within the source code; determine a respective status for each of the plurality of modules; display at a graphical user interface the respective status for each of the plurality of modules; parse the plurality of modules to determine whether any particular module has one of a plurality of predetermined internationalization issues; determine that a particular module has one of the plurality of predetermined internationalization issues; in response to determining that a particular module has one of the plurality of predetermined internationalization issues, automatically update the respective status of the particular module to a first status; modify the particular module to address the one of the plurality of predetermined internationalization issues; and in response to modifying the particular module, automatically update the respective status from the first status to a second status.

Other objects, features, and advantages will be apparent to persons of ordinary skill in the art from the following detailed description and the accompanying drawings.

### BRIEF DESCRIPTION OF THE DRAWINGS

Aspects of the present disclosure are illustrated by way of example and are not limited by the accompanying figures with like references indicating like elements.

FIG. 1 illustrates a schematic representation of a system architecture for an internationalization process.

FIG. 2A illustrates a schematic representation of a Kanban visualization mechanism.

FIG. 2B illustrates a schematic representation of a card of the Kanban visualization mechanism.

FIG. 3 illustrates a schematic representation of utilizing the Kanban visualization mechanism to manage the internationalization process.

FIG. 4 illustrates a flow chart for utilizing the Kanban visualization mechanism to detect and manage the internationalization process.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely in software (including firmware, resident software, micro-code, etc.) or in a combined software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would comprise the following: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. In the context of this document, a computer readable storage medium may be any tangible medium able to contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take a variety of forms comprising, but not limited to, electro-magnetic, optical, or a suitable combination thereof. A computer readable signal medium may be a computer readable medium that is not a computer readable storage medium and that is able to communicate, propagate, or transport a program for use by or in connection with an instruction execution system, apparatus, or device. Program code embodied on a computer readable signal medium may be transmitted using an appropriate medium, comprising but not limited to wireless, wireline, optical fiber cable, RF, etc., or any suitable combination of the foregoing.

Computer program code for carrying out operations for aspects of the present disclosure may be written in a combination of one or more programming languages, comprising an object oriented programming language such as JAVA®, SCALA®, SMALLTALK®, EIFFEL®, JADE®, EMERALD®, C++, C#, VB.NET, PYTHON® or the like, conventional procedural programming languages, such as the “C” programming language, VISUAL BASIC®, FORTRAN® 2003, Perl, COBOL 2002, PHP, ABAP®, dynamic programming languages such as PYTHON®, RUBY® and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider) or in a cloud computing environment or offered as a service such as a Software as a Service (“SaaS”).

Aspects of the present disclosure are described herein with reference to flowchart illustrations and/or block diagrams of methods, apparatuses (e.g., systems), and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, may direct a computer, other programmable data processing apparatus, or other devices to function in a particular manner, such that the instructions, when stored in the computer readable medium, produce an article of manufacture comprising instructions which, when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices to produce a computer implemented process, such that the instructions which execute on the computer or other programmable apparatus provide processes for implementing the functions/acts specified in the flowchart and/or block diagram block or blocks.

While certain example systems and methods disclosed herein may be described with reference to infrastructure management, systems and methods disclosed herein may be related to other areas beyond network infrastructure. Systems and methods disclosed herein may be related to, and used by, any predictive system that utilizes expert learning or other predictive methods. Systems and methods disclosed herein may be applicable to a broad range of applications that, such as, for example, research activities (e.g., research and design, development, collaboration), commercial activities (e.g., sales, advertising, financial evaluation and modeling, inventory control, asset logistics and scheduling), IT systems (e.g., computing systems, cloud computing, network access, security, service provisioning), medicine (e.g., diagnosis or prediction within a particular specialty or sub-specialty), and other activities of importance to a user or organization.

Although internationalization techniques exist for computer software applications, they do not leverage cost-savings from early detection of internationalization issues. The cost of internationalizing and localizing existing software is usually very expensive. Companies typically may invest several million dollars in localization per year, both internal and outsourced localization. Early detection of internationalization and localization issues could result in up to 70% savings in software localization costs. Traditionally, most of the internationalization efforts are at a later stage in the product development lifecycle, usually after the English build is ready and localization process has started. Typically, during Language QA stage, coding issues that affect product localization are identified. However, by this stage, these issues have multiplied by the number of target languages and fixing the issues may be cumbersome and error prone in the absence of early detection capabilities. In general, most software development processes establish walls between developers, technical writers, and the localization teams. This may translate into slow and expensive internationalization and localization processes, which may prevent companies from effectively innovating and adapting in a dynamic market.

In view of the foregoing, a need has arisen for early detection of internationalization issues by integrating localization-supporting tools within existing product development frameworks to identify and eliminate internationalization issues early in the product development cycle, and to track and manage the localization process through a visual mechanism.

Systems and methods disclosed herein may provide a system to support internationalization-friendly agile product development to enable continuous integration and delivery by detecting potential internationalization issues. In particular, utilizing a Kanban-like visualization mechanism to visualize and control and track the progress of an internationalization issue detection process in software development. Merriam-Webster Unabridged defines Kanban as a Japanese sign, placard, card used on assembly lines to control production and delivery of parts. In the context of software development, Kanban may provide a visual process-management system to aid decision-making and manage the end-to-end software development cycle, by presenting all participants in the software development process with a view of the progress of individual items and tasks.

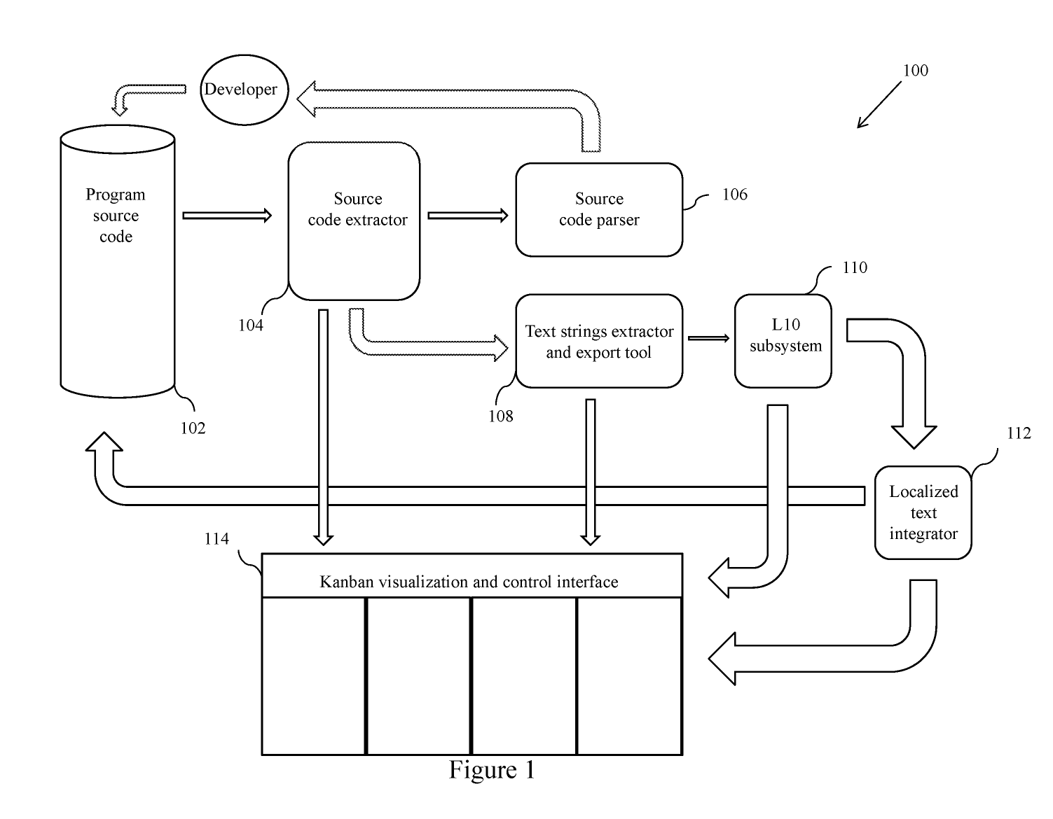

Referring now to FIG. 1, an embodiment of an overall system architecture for detecting internationalization issues in source code is depicted. The system uses a Kanban-like approach to visualize and control the internationalization process including: internationalization-readiness analysis of software under development and the support for developers to solve internationalization issues as early as possible; automatic extraction of data files (also known as resource files) from the executable code of the program for localization; localization; and integration of the localized text back into the resource files. The system 100 of FIG. 1 may include a plurality of modules to perform the internationalization process including program source code or resource file 102 being developed by a developer, source code extractor 104, source code parser/analyzer 106, text string extractor and export tool 108, localization subsystem 110, localized text integrator 112, and Kanban visualization and control interface 114. System 100 connects the different components and subsystems for the internationalization process to Kanban visualization and control interface 114 and the components and subsystems generate information that is translated automatically intro actions at the Kanban 114.

Source code extractor 104 may be embedded in an integrated development environment (IDE) or a code repository, such as GitHub. Source code extractor 104 may read the code and send it to source code parser/analyzer 106 to detect issues related to internationalization. Source code extractor 104 may also detect the different components in the source code application architecture and send such information to Kanban visualization and control interface 114. Kanban visualization and control interface 114 may be used to visualize the current status of the software internationalization process and control the internationalization/localization process of a particular software component or product. System 100 may allow a user to select components in the architecture which require internationalization processing and selected components may be automatically loaded into the Kanban.

Source code parser/analyzer 106 may be used to detect issues related to i18n. Source code parser/analyzer 106 may be a standalone application installed on the customer or user's system or a SaaS offering. Source code parser/analyzer 106 may be a system that can parse source code written in multiple programming languages. The programming languages may include Java, C, C++, but may be any suitable programming language and are not limited to a programming language that is expressed through text format. Source code parser/analyzer 106 may detect issues related to coding practices that will make it difficult to internationalize the software later on. Examples of typical internationalization code issues include date/time and number formatting, Unicode character set not supported, etc. Source code parser/analyzer 106 may generate warning and error messages for a software developer to use in solving existing issues. Source code parser/analyzer 106 may inform Kanban visualization and control interface 114 that a particular piece of source code has been analyzed. Kanban visualization and control interface 114 controls the overall process and contains a plurality of columns representing the different phases of the internationalization process and a plurality of cards representing the different components in an application or product to be processed. Kanban visualization and control interface 114 may be used to visualize the current status of the software internationalization process and may also allow a user to intervene, e.g., creating a exceptions when particular components do not need to go through the internationalization process or requesting some components go through pervious steps if they have undergone changes, by interacting with cards in Kanban visualization and control interface 114.

Text string extractor and export tool 108 may be a module to extract and export externalized text strings from the source code resource files that require translation. Tool 108 may send the text in a particular format to localization subsystem 110. Localization subsystem 110 localizes or translates the text strings appearing in the code. Subsystem 110 may rely on translation memories, machine translations, a crowdsourcing platform for post-editing, or any other suitable translation tool. An example of an existing crowdsourcing platform for translation and localization is Crowdin. Subsystem 110 may inform Kanban visualization and control interface 114 that a particular text is already localized and ready for integration back into the source code/resource files. Text integrator 112 may be a module to integrate the localized text into the source code/resource files. Integrator 112 may also inform Kanban visualization and control interface 114 that a particular text is already localized and ready for the integration back into the source code/resource files.

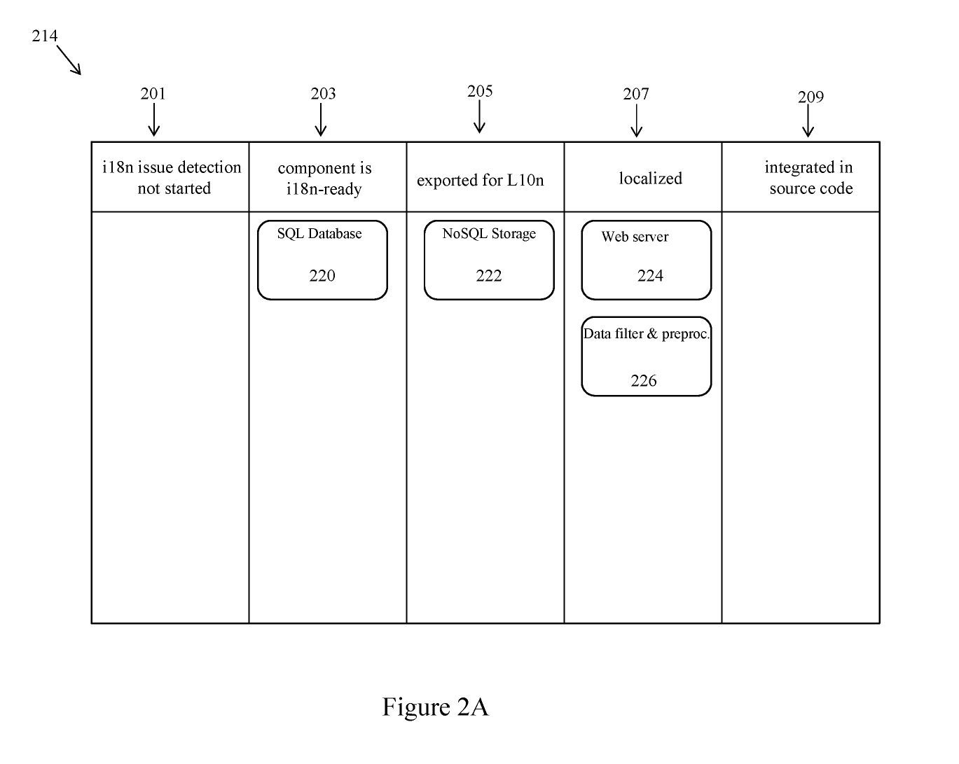

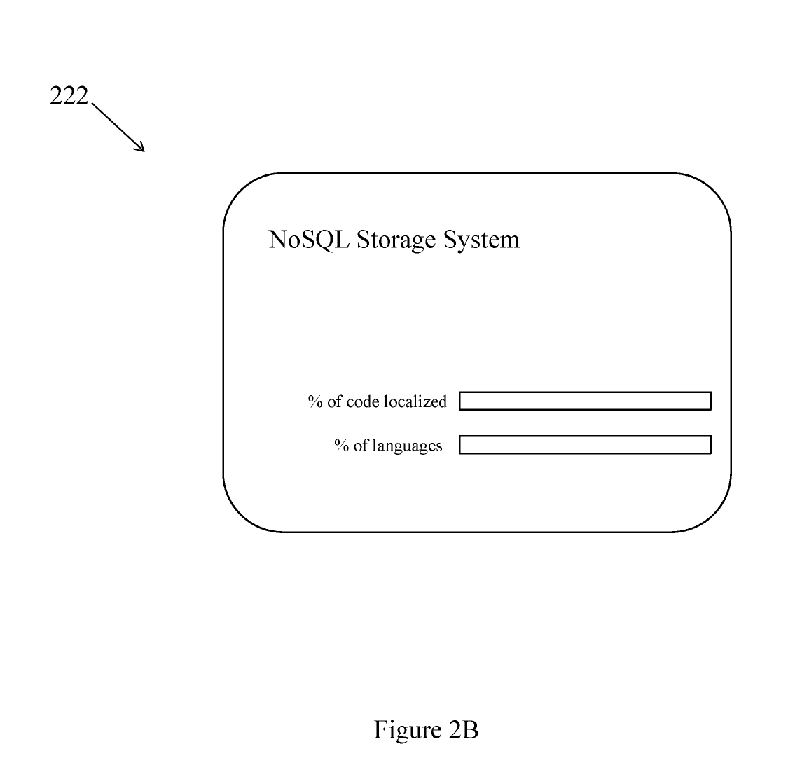

Referring now to FIG. 2A, an embodiment of a Kanban visualization and control interface 214, similar to Kanban visualization and control interface 114, is depicted. In this example, the different application architecture components are mapped in a Kanban 214, where each column represents one of the steps through which a particular component needs to go to be fully internationalized. Kanban visualization and control interface 214 may include a plurality of columns 201, 203, 205, 207, 209 and a plurality of cards 220, 222, 224, 226, with each card being disposed within a particular column of Kanban visualization and control interface 214. Columns 201, 203, 205, 207, 209 in Kanban 214 may represent different phases of the internationalization/localization process. The different phases may include i18n issue detection not started, component is i18n-ready, exported for L10n, localized, integrated in source code. Cards 220, 222, 224, 226 in Kanban 214 may represent different components in a software application or product to be processed. Cards 220, 222, 224, 226 in the Kanban 214 may also represent different products to enable monitoring internationalization of several products at the same time. The embodiment of FIG. 2A depicts the different application architecture components 220, 222, 224, 226 mapped in Kanban 214 where each column 201, 203, 205, 207, 209 represents one of the steps through which a particular component 220, 222, 224, or 226 needs to go in order to be fully internationalized.

The following steps of an internationalization process are depicted in the embodiment of FIG. 2A: i18n issue detection not started for the components in a first step (column 201), components in a second step are i18n ready, i.e., they do not contain i18n issues (column 203), components are exported in an appropriate format to begin localization in a third step (column 205), text extracted from a particular component is localized in a fourth step (column 207), and text has been integrated back into resource files in a fifth step (column 209). Other steps may be included in the internationalization process depending on the particular needs or method used to internationalize the software product.

Different actions in the system may generate automatic changes in the Kanban 214. For example, after the source code is extracted and the code analyzer detects no internationalization-related issues, this component triggers information to be sent to the Kanban to automatically move the related component from the first step to the second step. After a process to extract relevant text to be localized is completed, the module responsible for that action will inform the Kanban 214 and the corresponding card will move automatically from the second step to the third step.

Cards 220, 222, 224, or 226 may also include visual mechanisms to depict the level of progress of the components in the localization process, such as the third step (205) depicted in Kanban 214. FIG. 2B shows a simple example of card 222 with a visual mechanism to depict the level of progress of a component, such as a NoSQL Storage System, in the localization process. In the embodiment of FIG. 2B, the percentage of words translated and the percentage of requested languages per component are illustrated (card 222 in column 205). The status of a particular component 220, 222, 224, or 226 with respect to its internationalization process progress may also be emphasized through other visualization strategies, such as using different background colors for the components represented on Kanban 214.

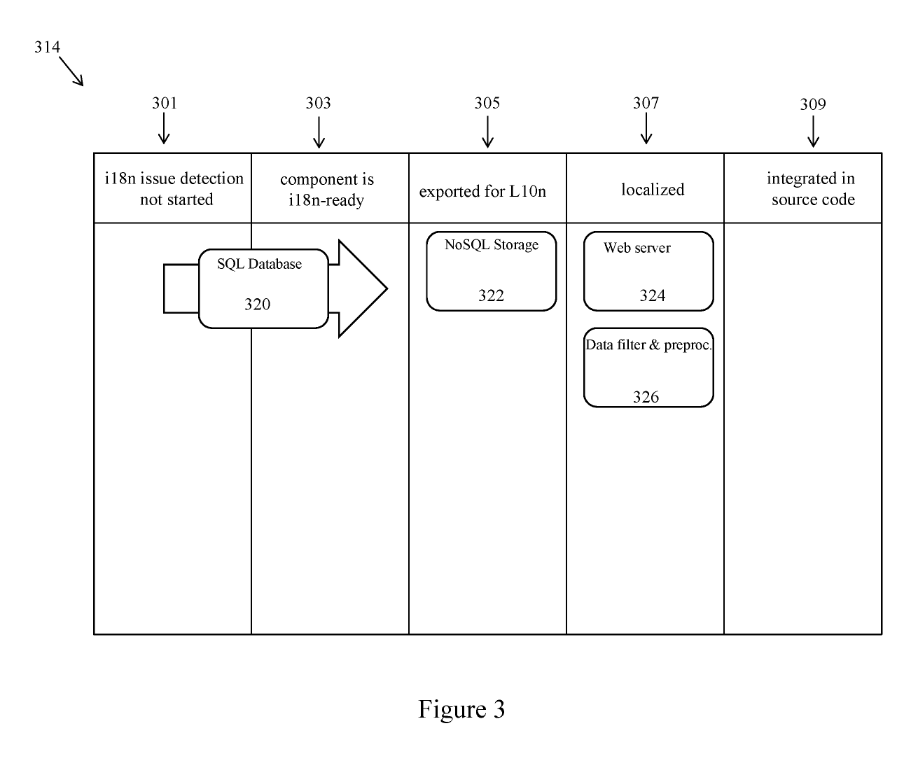

Referring now to FIG. 3, automatic movement of a component in an embodiment of Kanban visualization and control interface 314, similar to Kanban visualization and control interfaces 114 & 214, is depicted. In particular, different actions in the system may generate automatic changes in the Kanban 314 (similar to Kanban 214 depicted in FIG. 2). For example, after source code is extracted and the source code parser/analyzer detects no internationalization-related issues, this component may trigger information to be sent to the Kanban 314 to automatically move the related card 320 corresponding to the component from step 1 (column 301) to step 2 (column 303) (as shown in FIG. 3). In another example, the source code parser/analyzer may detect that the code of a component in the system, such as an SQL database, does not contain any known issue for internationalization. Therefore, parser/analyzer sends information to Kanban 314 and card 320, corresponding to the SQL database, is automatically moved to the next column of Kanban 314. As a further example, after the process to extract relevant text to be localized is completed, the module responsible for this action, i.e., localization subsystem 110, may inform Kanban 314 and card corresponding to the component will automatically move from column 305 (exported for L10n) to column 307 (localized).

Kanban 314 may also allow a user to manually change the position of a card(s). For example, a Product Owner may know that a particular component is part of a system that will not be internationalized. The Product Owner may decide to drag and drop the card corresponding to the particular component manually to the last column of Kanban 314. Manual drag and drop actions in Kanban 314 may generate actions automatically in the system, such as skipping an ongoing internationalization process if a card is moved to the last column, eliminating a particular ongoing localization process, and extracting the source code of that component again from the code repository to start the internationalization issue detection process again if a card is moved from step 3 (column 205, 305) to step 1 (column 201, 301).

A user may also manually intervene in the internationalization process and request some components go through previous steps if the source code/resource files have undergone important changes. A user may also manually intervene in the internationalization process by indicating that a particular component does not need to go through the internationalization issue detection process. This manual intervention may be carried out through interacting with the 320, 322, 324,326 in Kanban 314, such as via a drag and drop action, or any other suitable user input to Kanban 314. A user may also select components of an application architecture, such as from those identified by the source code extractor 104, that require internationalization processing. The selected components may be automatically loaded in Kanban 314.

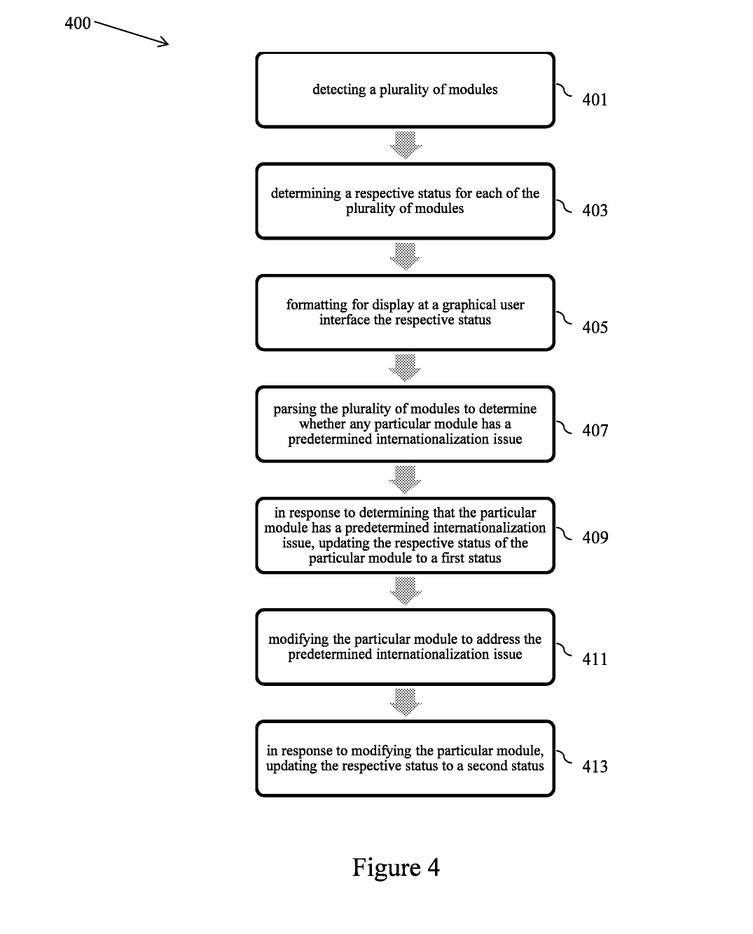

Referring now to FIG. 4, a flow diagram of a process 400 for utilizing the Kanban visualization mechanism to detect and manage the internationalization process is depicted. At 401, a plurality of modules within source code are detected. A respective status for each of the plurality of modules is determined at 403. At 405, the respective status for each of the plurality of modules is formatted for display at a graphical user interface. The plurality of modules are parsed to determine whether any particular module has one of a plurality of predetermined internationalization issues at 407. At 409, in response to determining that the particular module has one of the plurality of predetermined internationalization issues, the respective status of the particular module is updated to a first status. At 411, the particular module is modified to address the one of the plurality of predetermined internationalization issues. In response to modifying the particular module, the respective status is updated from the first status to a second status at 413.

The flowchart and block diagrams in the figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
detecting a plurality of modules within source code;
determining a respective status for each of the plurality of modules;
formatting for display at a graphical user interface the respective status for each of the plurality of modules;
parsing the plurality of modules to determine whether any particular module has one of a plurality of predetermined internationalization issues;
determining that a particular module has one of the plurality of predetermined internationalization issues;
in response to determining that the particular module has one of the plurality of predetermined internationalization issues, updating the respective status of the particular module to a first status;
modifying the particular module to address the one of the plurality of predetermined internationalization issues; and
in response to modifying the particular module, updating the respective status from the first status to a second status.

2. The method of claim 1, wherein modifying the particular module to address the one of the plurality of predetermined internationalization issues comprises extracting a data file of the particular module from a software development environment.

3. The method of claim 2, wherein the data file of the particular module extracted from the development environment comprises a text string having the one of the plurality of predetermined internationalization issues.

4. The method of claim 1, wherein the particular module comprises a first particular module and the one of the plurality of predetermined internationalization issues comprises a first predetermined internationalization issue, and further comprising:
determining that a second particular module of the plurality of modules has a second predetermined internationalization issue of the plurality of predetermined internationalization issues that is different from the first predetermined internationalization issue;
in response to determining that the second particular module has the second predetermined internationalization issue, updating the respective status of the second particular module to the first status;
modifying the second particular module to address the second predetermined internationalization issue; and
in response to modifying the second particular module, updating the respective status of the second particular module from the first status to the second status.

5. The method of claim 1, further comprising, displaying the respective status for each of the plurality of modules at the graphical user interface.

6. The method of claim 1, wherein updating the respective status of the particular module to a first status comprises:
sending a first signal to the graphical user interface indicating the respective status of the particular module has been updated to the first status; and
automatically updating the graphical user interface to reflect that the respective status has been updated to the first status.

7. The method of claim 1, wherein determining that the particular module has one of the plurality of predetermined internationalization issues comprises:
accessing a set of internationalization rules corresponding to a particular programming language of the source code; and
using the set of internationalization rules to detect portions of the source code of the particular module containing potential internationalization issues.

8. The method of claim 1, wherein the particular module comprises a first particular module and further comprising:
determining that a second particular module of the plurality of modules does not include any of the plurality of predetermined internationalization issues; and
in response to determining that the second particular module does not include any of the plurality of predetermined internationalization issues, automatically updating the respective status of the second particular module to a third status.

9. The method of claim 1, further comprising generating an error message for use by a developer of the source code to address the detected issues.

10. A computer configured to access a storage device, the computer comprising:
a graphical user interface;
a processor; and
a non-transitory, computer-readable storage medium storing computer-readable instructions that when executed by the processor cause the computer to perform:
detecting a plurality of modules within source code;
determining a respective status for each of the plurality of modules;
formatting for display at the graphical user interface the respective status for each of the plurality of modules;
parsing the plurality of modules to determine whether any particular module has one of a plurality of predetermined internationalization issues;
determining that a particular module has one of the plurality of predetermined internationalization issues;
in response to determining that a particular module has one of the plurality of predetermined internationalization issues, updating the respective status of the particular module to a first status;
modifying the particular module to address the one of the plurality of predetermined internationalization issues; and
in response to modifying the particular module, updating the respective status from the first status to a second status, wherein updating the respective status of the particular module to the second status results in a corresponding change at the graphical user interface.

11. The computer of claim 10, wherein the particular module comprises a first particular module and the one of the plurality of predetermined internationalization issues comprises a first predetermined internationalization issue, and the computer-readable instructions further comprise instructions that when executed by the processor cause the computer to perform:
determine that a second particular module of the plurality of modules has a second predetermined internationalization issue of the plurality of predetermined internationalization issues that is different from the first predetermined internationalization issue;
in response to determining that the second particular module has the second predetermined internationalization issue, update the respective status of the second particular module to the first status;
modify the second particular module to address the second predetermined internationalization issue; and
in response to modifying the second particular module, update the respective status of the second particular module from the first status to the second status.

12. The computer of claim 10, wherein the graphical user interface comprises a Kanban visualization mechanism.

13. The computer of claim 12, wherein the first particular module is represented as a first icon at the graphical user interface, the first status is represented as a first column at the graphical user interface, and the second status is represented as a second column at the graphical user interface.

14. The computer of claim 13, wherein the corresponding change at the graphical user interface comprises automatically moving the first icon from the first column to the second column at the graphical user interface.

15. A non-transitory computer-readable storage medium having instructions stored thereon that are executable by a computing system to:
detect a plurality of modules within the source code;
determine a respective status for each of the plurality of modules;
display at a graphical user interface the respective status for each of the plurality of modules;
parse the plurality of modules to determine whether any particular module has one of a plurality of predetermined internationalization issues;
determine that a particular module has one of the plurality of predetermined internationalization issues;
in response to determining that a particular module has one of the plurality of predetermined internationalization issues, automatically update the respective status of the particular module to a first status;
modify the particular module to address the one of the plurality of predetermined internationalization issues; and
in response to modifying the particular module, automatically update the respective status from the first status to a second status.

16. The non-transitory computer-readable storage medium of claim 15, wherein the particular module comprises a first particular module and the one of the plurality of predetermined internationalization issues comprises a first predetermined internationalization issue and the instructions are executable by the computing system to:
determine that a second particular module of the plurality of modules has a second predetermined internationalization issue of the plurality of predetermined internationalization issues that is different from the first predetermined internationalization issue;
in response to determining that the second particular module has the second predetermined internationalization issue, update the respective status of the second particular module to the first status;
modifying the second particular module to address the second predetermined internationalization issue; and
in response to modifying the second particular module, update the respective status of the second particular module from the first status to the second status.

17. The non-transitory computer-readable storage medium of claim 15, wherein to determine that a particular module has one of the plurality of predetermined internationalization issues, the instructions are executable by the computing system to:
access a set of internationalization rules corresponding to a particular programming language of the source code;
scan the particular module against the set of internationalization rules; and
identify portions of the source code of the particular module where potential internationalization issues are located.

18. The non-transitory computer-readable storage medium of claim 15, wherein to modify the particular module to address the one of the plurality of predetermined internationalization issues, the instructions are executable by the computing system to:
extract a text string containing the one of the plurality of predetermined internationalization issues;
export the text string;
localize the text string; and
integrate the text string back into the source code of the particular module.

19. The non-transitory computer-readable storage medium of claim 15, wherein the particular module comprises a first particular module and instructions are executable by the computing system to:
receive an indication that a second particular module of the plurality of modules does not need to be processed for internationalization issues; and
in response to receiving the indication, automatically update the respective status of the second particular module to a third status.

20. The non-transitory computer-readable storage medium of claim 15, wherein the instructions are executable by the computing system to display at the graphical user interface the respective status for each of the plurality of modules.
